(19) United States
(12) Patent Application Publication
(10) Pub. No.: US 2022/0120662 A1
(43) Pub. Date: Apr. 21, 2022

(54) PARTICLE INSPECTION DEVICE BASED ON SPATIAL MODULATION METHOD AND PARTICLE INSPECTION METHOD USING THE PARTICLE INSPECTION DEVICE

(71) Applicant: SAMSUNG ELECTRONICS CO., LTD., Suwon-si (KR)

(72) Inventors: Sangwoo BAE, Seoul (KR); Boris AFINOGENOV, Suwon-si (KR); Maksim RIABKO, Suwon-si (KR); Anton MEDVEDEV, Suwon-si (KR); Aleksandr SHOROKHOV, Suwon-si (KR); Anton SOFRONOV, Suwon-si (KR); Ingi KIM, Seoul (KR); Jungwook KIM, Seongnam-si (KR); Youngjoo LEE, Hwaseong-si (KR); Kyunghun HAN, Hwaseong-si (KR)

(73) Assignee: SAMSUNG ELECTRONICS CO., LTD., Suwon-si (KR)

(21) Appl. No.: 17/215,185

(22) Filed: Mar. 29, 2021

(30) Foreign Application Priority Data
Oct. 16, 2020 (KR) 10-2020-0134089

(51) Int. Cl. G01N 15/14

(52) U.S. Cl. CPC G01N 15/1434; G01N 2015/1493; G01N 15/1463

(57) ABSTRACT

A particle inspection method includes irradiating a spatially modulated modulation beam onto a surface of a substrate and detecting an absorption light signal from a reflection beam generated through reflection of the spatially modulated modulation beam by the substrate.

### CROSS-REFERENCE TO THE RELATED APPLICATION

This application claims priority from Korean Patent Application No. 10-2020-0134089, filed on Oct. 16, 2020, in the Korean Intellectual Property Office, the disclosure of which is incorporated by reference herein in its entirety.

### BACKGROUND

### 1. Field

The present disclosure relates to a particle inspection device based on a spatial modulation method and a particle inspection method using the particle inspection device.

### 2. Description of the Related Art

A particle inspection method performed on semiconductor devices is categorized into a bright field method, which irradiates light onto a portion to be inspected and uses light specularly-reflected from the portion, and a dark field method which uses diffusely-reflected light.

In the dark field method, a collector receives reflected and scattered light, and a point representing a specific intensity of the scattered light is represented as a defect position (for example, a particle position) of a semiconductor device. However, in the dark field method, when a particle is fine in size, it is difficult to measure intensity of reflected and scattered light, and due to this, the dark field method is unable to detect the particle.

### SUMMARY

It is an aspect to provide a particle inspection device for detecting a fine-size particle of 10 nm or less on the basis of a bright field method and a method of inspecting a particle by using the particle inspection device.

According to an aspect of one or more exemplary embodiments, there is provided a particle inspection method comprising irradiating a spatially modulated modulation beam onto a surface of a substrate; and detecting an absorption light signal from a reflection beam generated through reflection of the spatially modulated modulation beam by the substrate.

According to another aspect of one or more exemplary embodiments, there is provided a particle inspection method including performing a semiconductor device manufacturing process on a substrate, irradiating a spatially modulated modulation beam onto the substrate on which the semiconductor device manufacturing process has been performed, detecting an absorption light signal, generated from a particle located on a surface of the substrate, from a reflection beam generated through reflection of the spatially modulated modulation beam by the substrate, and detecting the particle from a variation of intensity of the absorption light signal with respect to a position of the substrate.

According to yet another aspect of one or more exemplary embodiments, there is provided a particle inspection device comprising a light source that generates a light beam; a vertical spatial modulation optical system that oscillates the light beam at a modulation frequency to generate a spatially modulated modulation beam and irradiate a substrate by the spatially modulated modulation beam; and a signal detector that is configured to detect a reflection beam generated through reflection of the spatially modulated modulation beam by the substrate and detect an absorption light signal from the reflection beam.

According to yet another aspect of one or more exemplary embodiments, there is provided a particle inspection device comprising a light source that generates a light beam: a deflector that oscillating the light beam at a modulation frequency to generate a modulation beam; a first lens that collimates the modulation beam; a second lens that converges the collimated modulation beam; an objective lens that transfers the modulation beam, passing through the second lens, to a substrate; a beam splitter that is disposed between the second lens and the objective lens and that changes a direction of a reflection beam generated through reflection by the substrate; a detector that detects the reflection beam; a lock-in amplifier that detects an absorption light signal having the modulation frequency from the reflection beam detected by the detector; and a processor that is configured to detect a particle, located on the substrate, from the absorption light signal.

### BRIEF DESCRIPTION OF THE DRAWINGS

FIG. 1 is a conceptual diagram schematically illustrating a configuration of a particle inspection device according to an embodiment;

FIG. 2 is an enlarged cross-sectional view illustrating an objective lens of the particle inspection device illustrated in FIG. 1:

FIG. 3 is an enlarged perspective view illustrating the objective lens of the particle inspection device illustrated in FIG. 1:

FIG. 4 is a flowchart for describing a method of inspecting a particle by using the particle inspection device of FIG. 1, according to an embodiment:

FIGS. 5 and 6 illustrate examples of diagrams illustrating that intensity of an absorption light signal generated from the particle is represented with respect to a position of a substrate when a light beam is irradiated onto the particle located on the substrate while the substrate is oscillating;

FIG. 7 shows distribution plots representing a comparison result of intensity of an absorption light signal with respect to a size of a particle:

FIG. 8 is a conceptual diagram schematically illustrating a configuration of a particle inspection device according to an embodiment; and

FIG. 9 is a conceptual diagram schematically illustrating a semiconductor manufacturing device including a particle inspection device according to an embodiment.

### DETAILED DESCRIPTION

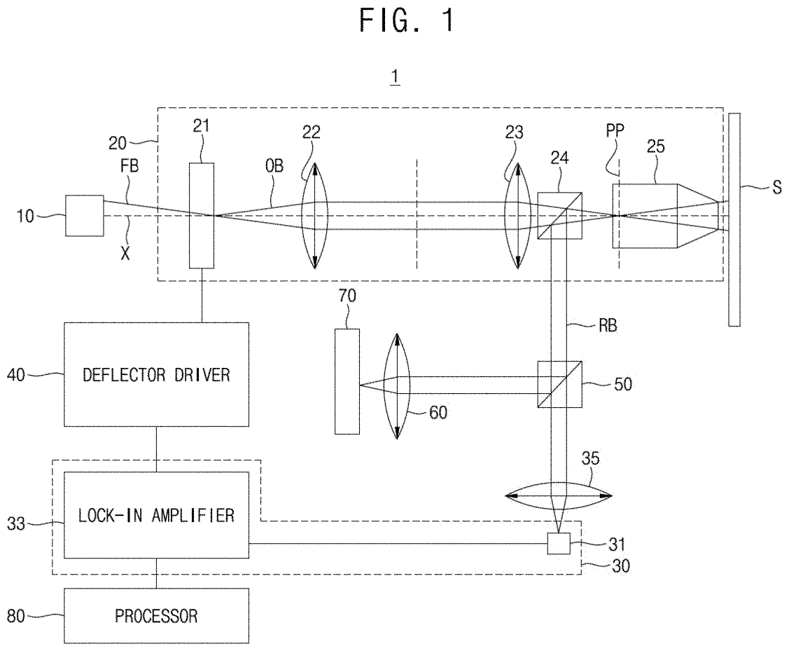

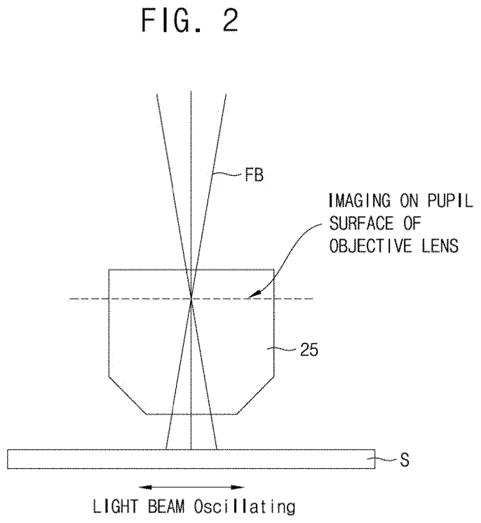

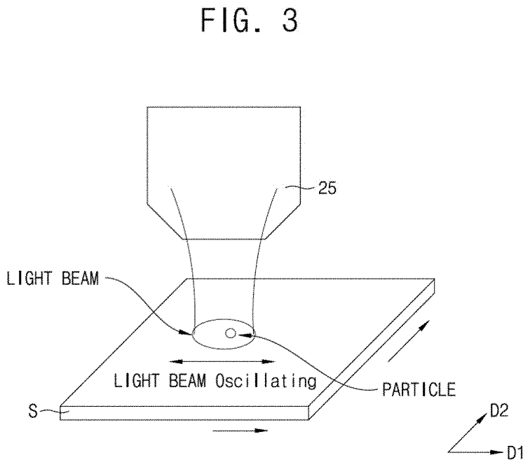

FIG. 1 is a conceptual diagram schematically illustrating a configuration of a particle inspection device 1 according to an embodiment. FIG. 2 is an enlarged cross-sectional view illustrating an objective lens of the particle inspection device 1 illustrated in FIG. 1. FIG. 3 is an enlarged perspective view illustrating the objective lens of the particle inspection device 1 illustrated in FIG. 1.

Referring to FIG. 1, the particle inspection device 1 may include a light source 10, a vertical spatial modulation optical system 20, a signal detector 30, a focusing lens 35, and a deflector driver 40. A substrate S which is an inspection target, the light source 10, and the vertical spatial modulation optical system 20 may be disposed in one row. In other words, the vertical spatial modulation optical system 20 may be in an optical path between the light source 10 and the substrate S. The light source 10 and the vertical spatial modulation optical system 20 may be disposed on a front surface of the substrate S. The vertical spatial modulation optical system 20 may be disposed between the light source 10 and the substrate S. The substrate S may be disposed on a stage (not shown), and the particle inspection device 1 may include a disposition mechanism for moving the stage (not shown) and the substrate S.

The light source 10 may generate a light beam FB. The light beam FB may be irradiated onto the substrate S through the vertical spatial modulation optical system 20. For example, the light beam FB may use various laser beams. In an embodiment, the light beam FB from the light source 10 may travel to a surface of the substrate S, and thus, the light source 10 may generate the light beam FB having a certain angle with respect to the surface of the substrate S. For example, the light source 10 may generate the light beam FB having a certain angle with respect to a central axis x vertical to the surface of the substrate S.

The vertical spatial modulation optical system 20 may include a deflector 21, a plurality of relay lenses 22 and 23, a first beam splitter 24, and an objective lens 25. The plurality of relay lenses 22 and 23 may include a first lens 22 and a second lens 23. The deflector 21, the first lens 22, the second lens 23, the first beam splitter 24, and the objective lens 25 may be sequentially disposed in one row between the light source 10 and the substrate S. For example, the deflector 21, the first lens 22, the second lens 23, the first beam splitter 24, and the objective lens 25 may be sequentially disposed in an optical path between the light source 10 and the substrate S.

The light beam FB generated by the light source 10 may be incident on the deflector 21. The deflector 21 may oscillate the incident light beam FB at a certain modulation frequency to generate a modulation beam OB. That is, the modulation beam OB exiting the deflector 21 may be bent at a certain angle with respect to a path of the light beam FB generated by the light source 10, and the certain angle may quickly vary. The deflector 21 may one-dimensionally oscillate the light beam FB. That is, the deflector 21 may oscillate the light beam OB in only one direction. For example, the deflector 21 may be one of an acousto-optic modulator (AOM) and an electro-optic modulator (EOM).

The modulation beam OB exiting the deflector 21 may sequentially pass through the first lens 22, the second lens 23, the first beam splitter 24, and the objective lens 25 and may be irradiated onto the substrate S. The first lens 22 may collimate the modulation beam OB, and the second lens 23 may allow the modulation beam OB to converge. Referring to FIGS. 1 and 2, the modulation beam OB passing through the first beam splitter 24 may focus (or imaging) on a pupil surface PP of the objective lens 25. The pupil surface PP of the objective lens 25 may be a Fourier transform surface which converts the modulating beam OB, passing through the objective lens 25, from a convergence beam into divergence beam.

The modulation beam OB may be oscillated by the deflector 21 and the modulation beam OB passing through the pupil surface PP of the objective lens 25 may diverge, and thus, the modulation beam OB may be oscillated on the substrate S. That is, a position, disposed on the substrate S, of the modulation beam OB passing through the objective lens 25 may be spatially modulated. When a spatially modulated modulation beam OB is irradiated onto a particle located on the substrate S, light may be absorbed by the particle, and an absorption light signal may occur due to the absorption of the light. The intensity of the absorption light signal caused by the particle may be proportional to a particle size raised to the power of 3. An intensity of a scatter signal, occurring when a light beam is scattered in the particle, may be proportional to the particle size raised to the power of 6 and the intensity of the absorption light signal may be proportional to a particle size raised to the power of 3, and thus, when the particle size is miniaturized to be equal to or less than a certain size, the intensity of the absorption light signal may be detected to be greater than the intensity of the scatter signal. Accordingly, instead of the scatter signal, the absorption light signal may be used to detect a particle having a fine size.

The modulation beam OB irradiated onto the substrate S may be reflected by the substrate S, and thus, a reflection beam RB may be generated. The reflection beam RB may pass through the objective lens 25 and to be incident on the first beam splitter 24. The first beam splitter 24 may change a direction of the reflection beam RB by 90 degrees. The reflection beam RB may include the absorption light signal caused by the particle.

Referring to FIGS. 1 and 3, in an embodiment, a stage may move while the modulation beam OB is being oscillated in one direction on the substrate S, thereby moving the substrate S. For example, while the modulation beam OB is being oscillated in a first direction D1, the substrate S may move in the first direction D1 and/or a second direction D2. Accordingly, the particle inspection device 1 may irradiate the modulation beam OB onto a whole surface of the substrate S on the basis of an area step method or an area scan method.

Referring again to FIG. 1, the signal detector 30 and the focusing lens 35 may be disposed at one side of the vertical spatial modulation optical system 20. The signal detector 30 may include a detector 31 and a lock-in amplifier 33. The detector 31 may be disposed at one side of the first beam splitter 24. For example, the detector 31 may be placed in a path through which the reflection beam RB generated through reflection by the substrate S passes after the direction thereof is changed by the first beam splitter 24. The focusing lens 35 may be disposed between the first beam splitter 24 and the detector 31. The focusing lens 35 may allow the reflection beam RB to focus on the detector 31. The lock-in amplifier 33 may be connected to the detector 31. For example, the detector 31 may include a photodiode. The signal detector 30 may include hardware circuitry to control the detector 31 and the lock-in amplifier 33. Alternatively, the signal detector 30 may include a microprocessor or central processing unit (CPU) and a memory that stores computer code which, when executed by the microprocessor or CPU, causes the microprocessor or the CPU to control the detector 31 and the lock-in amplifier 33.

The reflection beam RB generated through reflection by the substrate S may be irradiated onto the detector 31. The detector 31 may detect the reflection beam RB. In an embodiment, the lock-in amplifier 33 may measure the reflection beam RB detected by the detector 31 on the basis of a modulation frequency at which the deflector 21 modulates the light beam FB, thereby obtaining the absorption light signal based on the particle located on the substrate S. The lock-in amplifier 33 may remove noise signals having a frequency which differs from the modulation frequency and may detect only a signal having the modulation frequency, thereby obtaining the absorption light signal. That is, the lock-in amplifier 33 may selectively detect only a component, having the same frequency as the modulation frequency, of the reflection beam RB detected by the detector 31, and thus, may obtain the absorption light signal based on the particle located on the substrate S.

The deflector driver 40 may be connected to the deflector 21 and the lock-in amplifier 33. The deflector driver 40 may control the deflector 21 to oscillate the light beam OB at a certain modulation frequency. The certain modulation frequency may be predetermined. The deflector driver 40 may input a synchronization signal, having the same phase as that of the modulation frequency at which the deflector 21 oscillates the light beam FB, to the lock-in amplifier 33. The deflector driver 40 may include hardware circuitry to control the deflector 21 to oscillate the light beam OB and to input the synchronization signal to the lock-in amplifier 33. Alternatively, the deflector driver 40 may include a microprocessor or central processing unit (CPU) and a memory that stores computer code which, when executed by the microprocessor or CPU, causes the microprocessor or the CPU to control the deflector 21 to oscillate the light beam OB and to input the synchronization signal to the lock-in amplifier 33.

In an embodiment, the particle inspection device 1 may further include a processor 80. The processor 80 may represent the intensity of the absorption light signal detected by the lock-in amplifier 33 with respect to a position of the substrate S. For example, when the intensity of the absorption light signal detected by the lock-in amplifier 33 varies with respect to the position of the substrate S and thus is represented as a specific waveform or a distribution plot having a specific shape, the processor 80 may determine that the particle is on the substrate S. Also, the processor 80 may analyze a corresponding waveform or a shape of a corresponding distribution plot to detect a central position of the particle or to analyze a size of the particle. The processor 80 may include a microprocessor or central processing unit (CPU) and a memory that stores computer code which, when executed by the microprocessor or CPU, causes the microprocessor or the CPU to control the lock-in amplifier 33 and/or to determine that the particle is on the substrate and analyze the corresponding waveform or the shape of the corresponding distribution plot to detect the central positon of the particle or to analyze the size of the particle.

In an embodiment, the particle inspection device 1 may further include a second beam splitter 50, a third lens 60, and an image sensor 70. The second beam splitter 50 may be placed between the first beam splitter 24 and the detector 31 in a path through which the reflection beam RB passes between the first beam splitter 24 and the detector 31. The image sensor 70 may be disposed at one side of the second beam splitter 50. The image sensor 70 may be placed in a path through which the reflection beam RB having a direction changed by 90 degrees by the second beam splitter 50 passes. The third lens 60 may be disposed between the second beam splitter 50 and the image sensor 70. The third lens 60 may allow a beam, reflected by the second beam splitter 50, to focus on the image sensor 70. The image sensor 70 may have a function of imaging the substrate S. Therefore, the image sensor 70 may be used to align the substrate S at a desired position or to review the surface of the substrate S. For example, the image sensor 70 may include a complementary metal-oxide semiconductor (CMOS) image sensor.

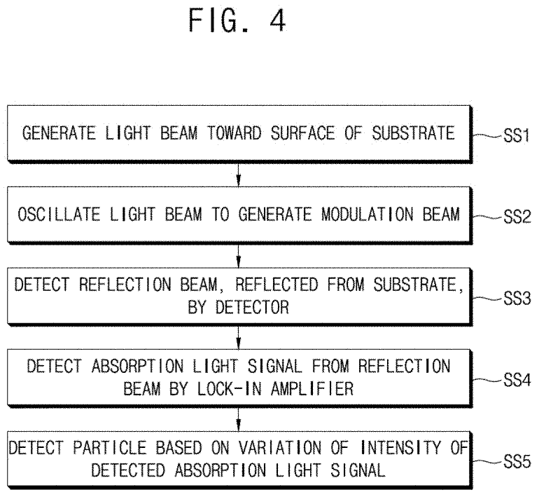

FIG. 4 is a flowchart for describing a method of inspecting a particle on a substrate by using the particle inspection device of FIG. 1, according to an embodiment.

Referring to FIGS. 1 and 4, the method may include an operation SS1 of generating the light beam FB toward the surface of the substrate S. The light beam FB generated by the light source 10 may be incident on the deflector 21. The light beam FB may travel at a certain angle with respect to the deflector 21. For example, the light beam FB may travel at a certain angle with respect to a central axis x which vertically passes through the deflector 21.

The method may include an operation SS2 of oscillating, by using the deflector 21, the light beam FB incident thereon to generate a modulation beam. That is, the deflector 21 may deflect the light beam FB at a high speed. The deflector 21 may operate based on control by the deflector driver 40. The deflector driver 40 may control the deflector 21 on the basis of a predetermined modulation frequency to oscillate the light beam FB. The modulation beam OB oscillated by the deflector 21 may pass through the first lens 22. The modulation beam OB passing through the first lens 22 may be collated and transferred to the second lens 23. The second lens 23 may allow the modulation beam OB collimated by the first lens 22 to converge. The modulation beam OB converged by the second lens 23 may pass through the first beam splitter 24 and may be incident on the objective lens 25.

The modulation beam OB may focus on the pupil surface PP of the objective lens 25. The pupil surface PP of the objective lens 25 may be placed at a focal distance of the second lens 23. Therefore, the light beam FB converged by the second lens 23 may pass through the first beam splitter 24 and may focus on the pupil surface PP of the objective lens 25.

The modulation beam OB, passing through the pupil surface PP of the objective lens 25, may be incident on the surface of the substrate S and to oscillate on the substrate S. That is, a position, onto which the modulation beam OB is irradiated, of the substrate S may be spatially modulated. When a spatially modulated modulation beam OB is irradiated onto a particle located on the substrate S, light may be absorbed by the particle, and an absorption light signal may occur due to the absorption of the light. Accordingly, the reflection beam RB generated through reflection by the surface of the substrate S may include the absorption light signal based on the particle.

The method may include an operation SS3 of detecting the reflection beam RB, generated by the modulation beam OB incident on the substrate S being reflected therefrom, by the detector 31. The reflection beam RB generated through reflection by the substrate S may pass through the objective lens 25, the first beam splitter 24, the second beam splitter 50, and the focusing lens 35 and may be incident on the detector 31. The detector 31 may detect a signal of the reflection beam RB.

The method may include an operation SS4 of detecting an absorption light signal from the reflection beam RB by the lock-in amplifier. For example, the signal of the reflection beam RB detected by the detector 31 may be measured to detect the absorption light signal. A synchronization signal, having the same phase as that of a modulation frequency of the light beam OB passing through the deflector 21, may be input to the lock-in amplifier 33, and the lock-in amplifier 33 may be synchronized with the modulation frequency. Therefore, the lock-in amplifier 33 may measure only a component, having the same frequency as the modulation frequency at which the deflector 21 modulates the light beam FB, of the reflection beam RB from which noise has been removed, thereby detecting the absorption light signal.

The method may include an operation SS5 of detecting the particle based on a variation in intensity of the detected absorption light signal. For example, the particle may be detected from a variation of intensity of the absorption light signal based on a position of the substrate S. For example, the processor 80 may represent the intensity of the absorption light signal detected by the lock-in amplifier 33 with respect to the position of the substrate S. For example, when the intensity of the absorption light signal detected by the lock-in amplifier 33 varies with respect to the position of the substrate S and thus has a specific waveform or a specific shape, the processor 80 may determine that the particle is on the substrate S. Also, the processor 80 may analyze a corresponding waveform to detect a central position of the particle or to analyze a size of the particle.

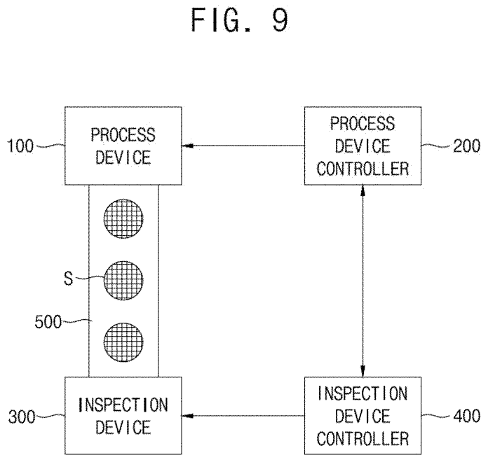

In an embodiment, the method of inspecting a particle described above may be performed before a semiconductor device manufacturing process is performed on a substrate. or may be performed after the semiconductor device manufacturing process is performed on the substrate. Alternatively, the method may be performed before the semiconductor device manufacturing process is performed on the substrate and after the semiconductor device manufacturing process is performed on the substrate. The semiconductor device manufacturing process will be described below in detail with reference to FIG. 9.

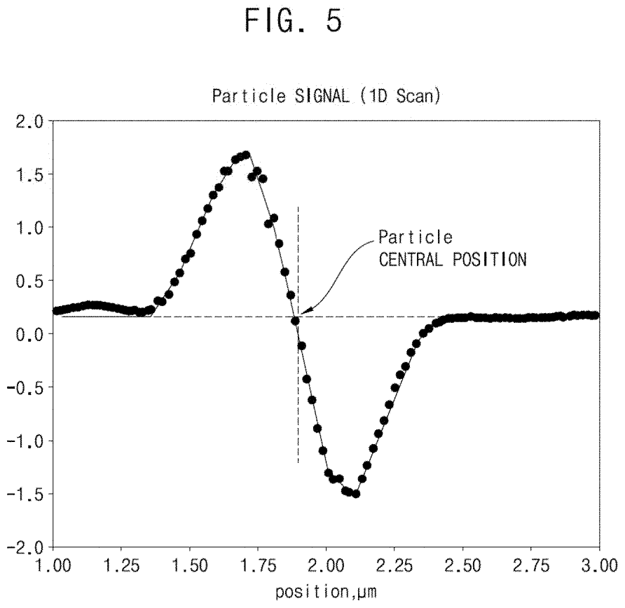

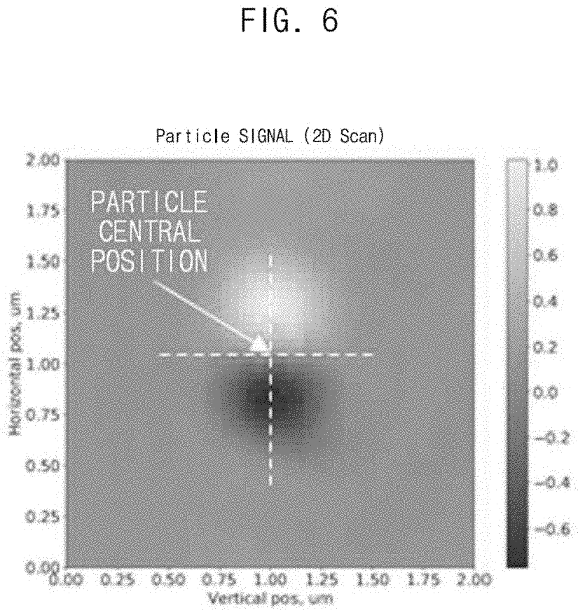

FIGS. 5 and 6 illustrate examples of diagrams illustrating that intensity of an absorption light signal generated from the particle is represented with respect to a position of a substrate when a light beam is irradiated onto the particle located on the substrate while oscillating.

Intensity of an absorption light signal, generated when a light beam oscillated by the particle inspection device according to an embodiment is irradiated on a particle located on a substrate, may be represented with respect to a position of the substrate, and in this case, a waveform of FIG. 5 may be shown or a distribution plot of FIG. 6 may be shown. FIG. 5 shows intensity of the absorption light signal based on the particle when the light beam is one-dimensionally scanned on the substrate and the particle without moving the substrate. FIG. 6 shows intensity of the absorption light signal based on the particle when the light beam is two-dimensionally scanned (i.e., area scan) on the substrate and the particle by moving the substrate. In a case where intensity of the absorption light signal detected by the lock-in amplifier 33 is represented with respect to the position of the substrate, when the waveform of FIG. 5 or a signal distribution shape of FIG. 6 is shown, the particle inspection device 1 according to an embodiment may determine that the particle is on the substrate. Particularly, the particle inspection device 1 may check whether a fine particle of 10 nm or less is on the surface of the substrate S. Also, the particle inspection device 1 may analyze a central position and/or a size of the particle from the waveform of the absorption light signal shown in FIG. 5 and/or the signal distribution shape of the absorption light signal shown in FIG. 6.

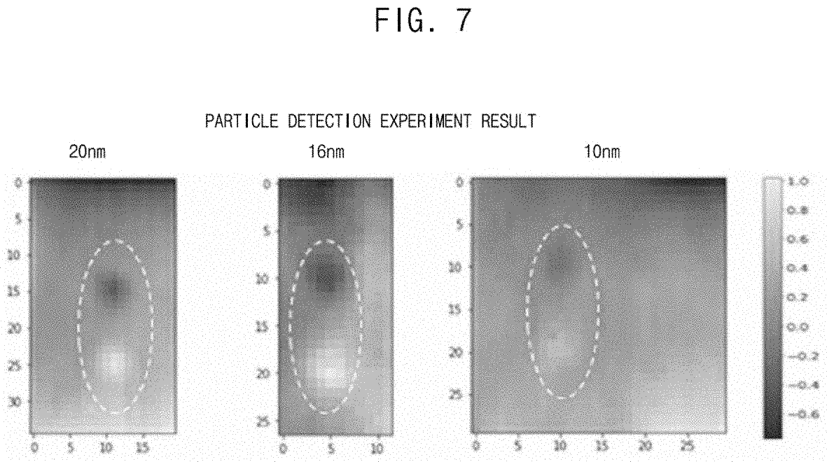

FIG. 7 shows distribution plots representing a comparison result of intensity of an absorption light signal with respect to a size of a particle.

Referring to FIG. 7, it may be checked that an absorption light signal based on a particle is detected from a particle of 10 nm as well as a particle of 20 nm and a particle of 16 nm.

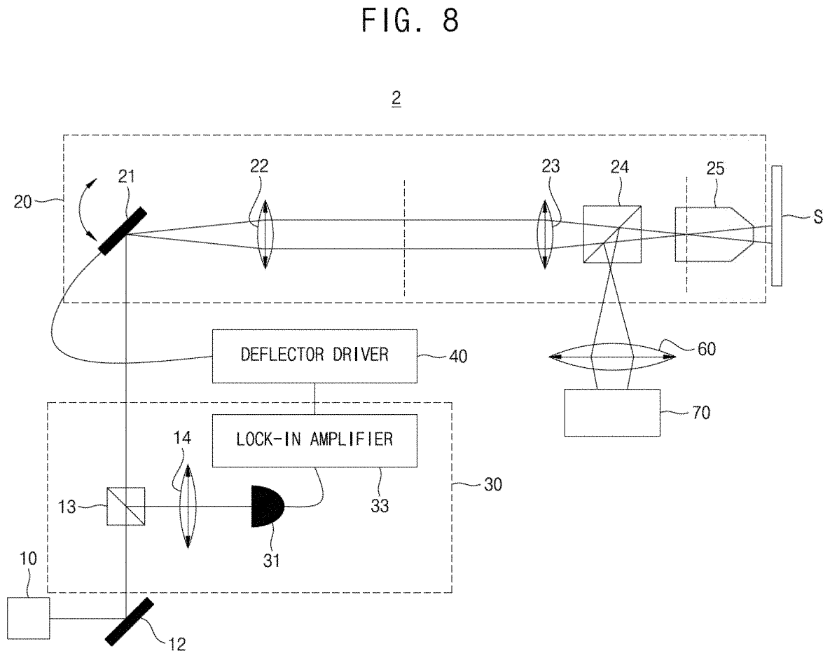

FIG. 8 is a conceptual diagram schematically illustrating a configuration of a particle inspection device 2 according to an embodiment.

Referring to FIG. 8, the particle inspection device 2 may include a light source 10, a mirror 12, a vertical spatial modulation optical system 20, a signal detector 30, and a deflector driver 40.

The vertical spatial modulation optical system 20 may include a deflector 21, a plurality of relay lenses 22 and 23, a first beam splitter 24, and an objective lens 25. The vertical spatial modulation optical system 20 of FIG. 8 may have the same configuration as that of the vertical spatial modulation optical system 20 of FIG. 1 described above, but there may be a difference therebetween in that the deflector 21 includes a polygon mirror or a Galvano mirror.

The light source 10 may irradiate a light beam onto the mirror 12, and the mirror 12 may reflect the light beam toward the deflector 21. The deflector 21 may reflect the light beam toward a substrate S, and in this case, the deflector 21 may oscillate the light beam to generate a modulation beam. Also, the deflector 21 may reflect the modulation beam, generated through reflection by the substrate S, toward the signal detector 30. In some embodiments, the mirror 12 may be omitted, and the light source 10 may be disposed at a position of the mirror 12, whereby the light beam may be irradiated onto the deflector 21.

The signal detector 30 may be disposed between the mirror 12 and the vertical spatial modulation optical system 20. The signal detector 30 may include a second beam splitter 13, a focusing lens 14, a detector 31, and a lock-in amplifier 33. The second beam splitter 13 may be placed in a path between the first beam splitter 24 and the detector 31 through which the light beam passes between the first beam splitter 24 and the detector 31. The second beam splitter 13 may transmit the light beam generated by the light source 10 and may change, by 90 degrees, a direction of the reflection beam generated through reflection by the substrate S to irradiate a direction-changed reflection beam onto the detector 31. The focusing lens 14 may be disposed between the second beam splitter 13 and the detector 31 and may allow the reflection beam to focus on the detector 31. The detector 31 may be connected to the lock-in amplifier 33. The deflector driver 40 may be connected to the deflector 21 and the lock-in amplifier 33. Each of the detector 31, the lock-in amplifier 33, and the deflector driver 40 may perform the same function as a function described above with reference to FIG. 1, and therefore a repeated description thereof is omitted for conciseness.

The particle inspection device 2 may further include a focusing lens 60 and an image sensor 70. The image sensor 70 may be disposed at one side of the first beam splitter 24, and the focusing lens 60 may be disposed between the image sensor 70 and the first beam splitter 24. The first beam splitter 24 may change a path of the reflection beam generated through reflection by the substrate S and may irradiate the reflection beam onto the image sensor 70. The focusing lens 60 and the image sensor 70 may perform the same functions as functions described above with reference to FIG. 1, and therefore a repeated description thereof is omitted for conciseness.

FIG. 9 is a conceptual diagram schematically illustrating a semiconductor manufacturing device including a particle inspection device according to an embodiment.

Referring to FIG. 9, the semiconductor manufacturing device may include a process device 100, a process device controller 200, an inspection device 300, and an inspection device controller 400.

The process device 100 may include various process devices for manufacturing a semiconductor device or an intermediate resultant material of a process of manufacturing the semiconductor device. For example, the process device 100 may include a device for performing various deposition processes such as atomic layer deposition (ALD), physical vapor deposition (PVD), chemical vapor deposition (CVD), pulsed laser deposition (PLD), vapor-phase epitaxy (VPE), and/or molecular beam epitaxy (MBE) processes. The process device 100 may include a photolithography device for performing photolithography processes such as a spin coating process, an exposure post bake process, and a development process. The process device 100 may include various process devices such as an etching device for performing an etching process, a cleaning device for performing a cleaning process, and a chemical-mechanical planarization (CMP) process. For example, the process device 100 may manufacture various semiconductor devices such as a central processor (CPU) device, a graphics processor (GPU) device, an application processor (AP) device, a CMOS device, a power device, and memory devices such as dynamic random access memory (DRAM), NAND flash memory, VNAND flash memory, resistive random access memory (ReRAM), magneto resistive random access memory (MRAM), and static random access memory (SRAM). The process device controller 200 may be connected to the process device 100 and may control the process device 100 to manufacture various semiconductor devices described above. The process device controller 200 may include a microprocessor or central processing unit (CPU) and a memory that stores computer code which, when executed by the microprocessor or CPU, causes the microprocessor or the CPU to control the process device 100 to manufacture various semiconductor devices.

The inspection device 300 may monitor in real time a substrate or a substrate on which a semiconductor process has been performed. The inspection device 300 may include the particle inspection device according to an embodiment described above with reference to FIG. 1 or 8. The particle inspection device may perform a particle detecting operation on a semiconductor structure on a substrate in a state where a semiconductor device manufacturing process is performed on the substrate by the process device 100 and some processes of a manufacturing process are performed. Alternatively, the particle inspection device may perform a particle detecting operation on a surface of the substrate before the semiconductor device manufacturing process is performed on the substrate. In an embodiment, the particle inspection device may perform a particle detecting operation before and after the semiconductor device manufacturing process is performed on the substrate. For example, the semiconductor device manufacturing process may include at least one of the deposition process, the photolithography process, the etching process, the cleaning process, and the CMP process. In an embodiment, the particle inspection device may detect a particle which occurs in the process device 100 after the process device 100 is repaired or maintained.

A particle detecting operation may be performed by the inspection device 300, and a substrate may be transferred to the process device by a transfer device 500. After the semiconductor device manufacturing process is performed by the process device 100, the transfer device 500 may move the substrate to the inspection device 300. The inspection device controller 400 may be connected to the inspection device 300 and may control the inspection device 300. In an embodiment, the inspection device controller 400 may analyze an inspection result obtained by the inspection device 300. The inspection device controller 400 may include a microprocessor or central processing unit (CPU) and a memory that stores computer code which, when executed by the microprocessor or CPU, causes the microprocessor or the CPU to control the inspection device 300 and/or analyze the inspection result obtained by the inspection device 300. The inspection device controller 400 may provide the analyzed inspection result to the process device controller 200. The process device controller 200 may provide a feedback signal to the process device 100 on the basis of the inspection result provided thereto.

According to the embodiments, a fine-size particle may be detected by detecting an absorption light signal which occurs due to the particle disposed on a substrate. Also, a size and a position of the particle causing the absorption light signal may be analyzed based on the absorption light signal.

Hereinabove, the various embodiments have been described with reference to the accompanying drawings, but it may be understood that those skilled in the art may implement the embodiments in another detailed form without changing the scope of the appended claims. It should be understood that the embodiments described above are merely examples in all aspects and are not limited.

What is claimed is:

1. A particle inspection method comprising:
irradiating a spatially modulated modulation beam onto a surface of a substrate; and
detecting an absorption light signal from a reflection beam generated through reflection of the spatially modulated modulation beam by the substrate.

2. The particle inspection method of claim 1, wherein the irradiating of the spatially modulated modulation beam comprises:
generating a light beam traveling toward the substrate; and
oscillating the light beam according to a modulation frequency to generate the spatially modulated modulation beam.

3. The particle inspection method of claim 2, wherein the spatially modulated modulation beam is focused on a pupil surface of an objective lens placed on the surface of the substrate.

4. The particle inspection method of claim 1, wherein the detecting of the absorption light signal comprises detecting a component, having a same frequency as a modulation frequency of the spatially modulated modulation beam, from the reflection beam.

5. The particle inspection method of claim 1, further comprising detecting a particle based on a variation of intensity of the absorption light signal with respect to a position of the substrate.

6. The particle inspection method of claim 1, further comprising analyzing the absorption light signal to detect a position of a particle in the substrate.

7. The particle inspection method of claim 1, further comprising analyzing the absorption light signal to analyze a size of a particle.

8. A particle inspection device comprising:
a light source that generates a light beam;
a vertical spatial modulation optical system that oscillates the light beam at a modulation frequency to generate a spatially modulated modulation beam and irradiate a substrate by the spatially modulated modulation beam; and
a signal detector that is configured to detect a reflection beam generated through reflection of the spatially modulated modulation beam by the substrate and detect an absorption light signal from the reflection beam.

9. The particle inspection device of claim 8, wherein the vertical spatial modulation optical system comprises:
a deflector that generates the spatially modulated modulation beam;
a relay lens including a first lens that collimates the spatially modulated modulation beam and a second lens that converges the collimated spatially modulated modulation beam;
a first beam splitter that irradiates the spatially modulated modulation beam onto the substrate and changes a direction of the reflection beam; and
an objective lens that transfers the spatially modulated modulation beam to the substrate.

10. The particle inspection device of claim 9, wherein
the spatially modulated modulation beam passes through the first beam splitter and focuses on a pupil surface of the objective lens, and
the spatially modulated modulation beam diverges from the pupil surface of the objective lens to the substrate and is spatially modulated in a surface of the substrate.

11. The particle inspection device of claim 9, wherein the deflector comprises one of an acousto-optic modulator (AOM), an electro-optic modulator (EOM), a polygon mirror, and a Galvano mirror.

12. The particle inspection device of claim 9, wherein the signal detector comprises:
a detector that detects the reflection beam; and
a lock-in amplifier that detects a component, having the modulation frequency, of the reflection beam detected by the detector.

13. The particle inspection device of claim 12, further comprising a deflector driver that drives the deflector at the modulation frequency,
wherein the deflector driver is connected to each of the deflector and the lock-in amplifier.

14. The particle inspection device of claim 12, further comprising a first focusing lens between the first beam splitter and the detector,
wherein the focusing lens focuses the reflection beam on the detector.

15. The particle inspection device of claim 12, further comprising:
a second beam splitter that is disposed between the first beam splitter and the detector and that splits the reflection beam;
an image sensor that receives a split reflection beam from the second beam splitter; and
a second focusing lens that is disposed between the second beam splitter and the image sensor and focuses the split reflection beam on the image sensor.

16. The particle inspection device of claim 9, wherein the signal detector comprises:
a second beam splitter that is disposed between the light source and the deflector and that changes a direction of the reflection beam that has passing through the vertical spatial modulation optical system;
a detector that detects the reflection beam;
a first focusing lens that is disposed between the detector and the second beam splitter; and
a lock-in amplifier that detects a component, having the modulation frequency, of the reflection beam detected by the detector.

17. The particle inspection device of claim 16, further comprising:
an image sensor that is disposed at one side of the first beam splitter and that receives the reflection beam whose direction has been changed by the first beam splitter; and
a second focusing lens that is disposed between the first beam splitter and the image sensor.

18. A particle inspection device comprising:
a light source that generates a light beam;
a deflector that oscillating the light beam at a modulation frequency to generate a modulation beam;
a first lens that collimates the modulation beam;
a second lens that converges the collimated modulation beam;
an objective lens that transfers the modulation beam, passing through the second lens, to a substrate;
a beam splitter that is disposed between the second lens and the objective lens and that changes a direction of a reflection beam generated through reflection by the substrate;
a detector that detects the reflection beam;
a lock-in amplifier that detects an absorption light signal having the modulation frequency from the reflection beam detected by the detector; and
a processor that is configured to detect a particle, located on the substrate, from the absorption light signal.

19. The particle inspection device of claim 18, wherein
the modulation beam passes through the beam splitter and focuses on a pupil surface of the objective lens, and
the modulation beam diverges from the pupil surface of the objective lens to the substrate and is spatially modulated in a surface of the substrate.

20. The particle inspection device of claim 19, further comprising a deflector driver that drives the deflector at the modulation frequency,
wherein the deflector driver is connected to each of the deflector and the lock-in amplifier.
